(19) United States
(12) Patent Application Publication
(10) Pub. No.: US 2024/0143703 A1
(43) Pub. Date: May 2, 2024

(54) ENTERTAINMENT SYSTEM USING NFT AND METAVERSE

(71) Applicant: JMG Co., Ltd., Seoul (KR)

(72) Inventor: Jae Hoon JANG, Incheon (KR)

(21) Appl. No.: 18/385,473

(22) Filed: Oct. 31, 2023

(30) Foreign Application Priority Data
Oct. 31, 2022 (KR) 10-2022-0142746

(51) Int. Cl. G06F 21/10; G06F 21/32; G06F 21/64; G06Q 20/06; G10L 19/018; H04L 9/00; H04L 9/32

(52) U.S. Cl. CPC G06F 21/10; G06F 21/32; G06F 21/64; G06Q 20/065; G10L 19/018; H04L 9/3231; H04L 9/50

(57) ABSTRACT

Provided is an entertainment system including: a creator terminal configured to transmit creative work information; an administrator terminal configured to select valid creative work information among the creative work information received from the creator terminal; a server configured to generate audio-visual data based on the valid creative work information uploaded by the administrator terminal and generate an non-fungible token (NFT) that corresponds one-to-one with the audio-visual data; an investor terminal configured to exchange the NFT generated by the server with a predetermined electronic currency; and a predetermined metaverse platform configured to generate the predetermined electronic money. According to an embodiment, valid creative information is converted into an NFT and traded using an electronic currency used within a metaverse platform, thereby minimizing copyright disputes arising from the provision of audio-visual data within a metaverse platform, and profits generated by providing audio-visual data within a metaverse platform are distributed based on NFTs.

### CROSS-REFERENCE TO RELATED APPLICATION

This application claims priority to and the benefit of Korean Patent Application No. 10-2022-0142746, filed on Oct. 31, 2022, in the Korean Intellectual Property Office, the disclosure of which is incorporated herein by reference in its entirety.

### BACKGROUND

### 1. Field of the Invention

The present invention relates to an entertainment system, and more specifically, to an entertainment system implemented in a metaverse and distributing profits using a non-fungible token (NFT).

### 2. Discussion of Related Art

With the increasing demand for online entertainment content, entertainment systems using a non-fungible token (NFT) and a metaverse are gaining attention. However, due to the lack of widely used methods for safely providing services related to the sale and use of copyrights in a virtual space without disputes, there have been limitations in offering the services.

Many creators access platforms to upload various works and create non-fungible tokens (NFTs), but there are many obstacles when investors select valuable works from among the large number of works and particularly, make profits based on the works streaming and the like within the metaverse platform.

In order to resolve the above described issues and meet the growing demand, the present invention provides an entertainment system using an NFT and a metaverse.

### SUMMARY OF THE INVENTION

The present invention is directed to providing an entertainment system capable of selecting valid creative work information having an investment value from a plurality of pieces of creative work information.

The present invention is also directed to providing an entertainment system capable of generating audio-visual data and an NFT based on selected valid creative work information, and exchanging the NFT with an electronic currency generated from a metaverse platform and used within the metaverse platform.

The present invention is also directed to providing an entertainment system capable of determining whether audio-visual data provided to a metaverse platform is forged.

According to an aspect of the present invention, there is provided an entertainment system including: a creator terminal configured to transmit creative work information; an administrator terminal configured to select valid creative work information among the creative work information received from the creator terminal; a server configured to generate audio-visual data based on the valid creative work information uploaded by the administrator terminal and generate an non-fungible token (NFT) that corresponds one-to-one with the audio-visual data; an investor terminal configured to exchange the NFT generated by the server with a predetermined electronic currency; and a predetermined metaverse platform configured to generate the predetermined electronic money.

In addition, according to an aspect of the present invention, there is provided an entertainment system in which an administrator terminal is configured to: perform face-to-face authentication based on receiving near-field communication (NFC) authentication data from the creator terminal to select valid creative work information; transmit non-face-to-face authentication data to a creator terminal that has performed face-to-face authentication a predetermined number of times or more to grant the creator terminal valid creative work upload authority, in which the non-face-to-face authentication data includes a combination of a fingerprint and a voice of a user of the creator terminal, a predetermined word, and a predetermined melody; and discard the non-face-to-face authentication data to deprive the creator terminal of the valid creative work upload authority when the creator terminal granted the valid creative work upload authority uploads valid creative work information that fails to meet a prescribed standard.

In addition, according to an aspect of the present invention, there is provided an entertainment system in which an electronic currency used in a predetermined metaverse platform is used, and a server is configured to insert an inaudible sound wave that corresponds one-to-one with a unique code of an NFT into audio-visual data and transmit the audio-visual data to the predetermined metaverse platform, and when the audio-visual data is image data having no playback time, convert the image data into video data having a playback time and insert the inaudible sound wave into the video data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an entertainment system according to an embodiment of the present invention;

FIG. 2 is a diagram illustrating an embodiment in which an administrator terminal performs a face-to-face authentication on a creator terminal according to an embodiment of the present invention;

FIG. 3 is a flowchart showing a process in which a creator terminal transmits creative work information and receives a profit share according to an embodiment of the present invention; and

FIG. 4 is a flowchart showing a process in which an administrator terminal selects valid creative work information from creative work information and grants a creator terminal the authority to upload valid creative work information according to an embodiment of the present invention.

### DETAILED DESCRIPTION OF EXEMPLARY EMBODIMENTS

The technical objectives and effects of the present invention may become apparent to those of ordinary skill in the art based on the following detailed descriptions, but they are not limited to the following description. In the description of the present invention, when it is determined that a detailed description of known related art unnecessarily obscures the subject matter of the present invention, the detailed description will be omitted.

Hereinafter, embodiments of the present invention will be described in detail with reference to the accompanying drawings to enable those skilled in the art to easily practice the present disclosure. However, the present invention may be embodied in various different forms, and is not to be constructed as limited to the embodiments set forth herein. In addition, in the drawings, parts irrelevant to the present invention are omitted, and the same or similar reference numerals are used to designate the same or similar elements.

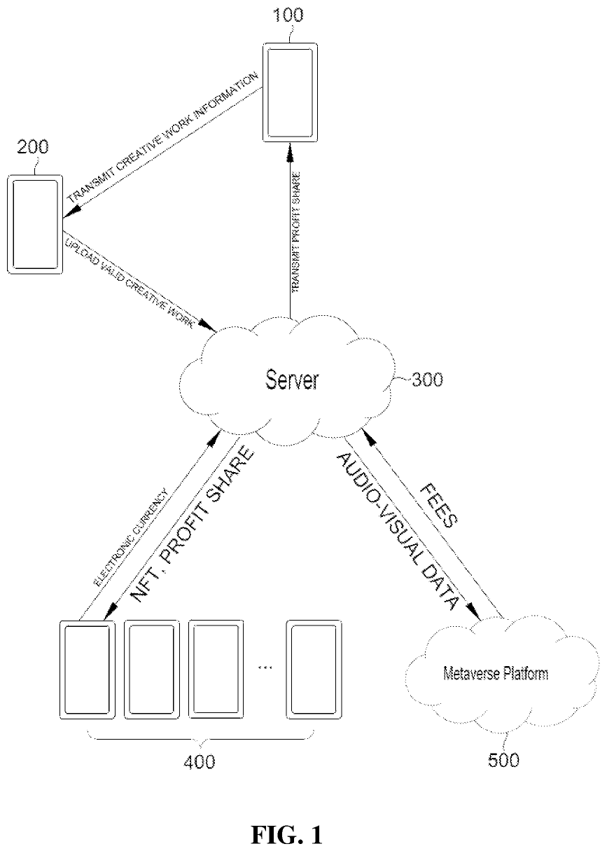

FIG. 1 is a block diagram illustrating an entertainment system according to an embodiment of the present invention. Referring to FIG. 1, an entertainment system according to an embodiment of the present invention includes a creator terminal, an administrator terminal, a server, an investor terminal, and a metaverse platform.

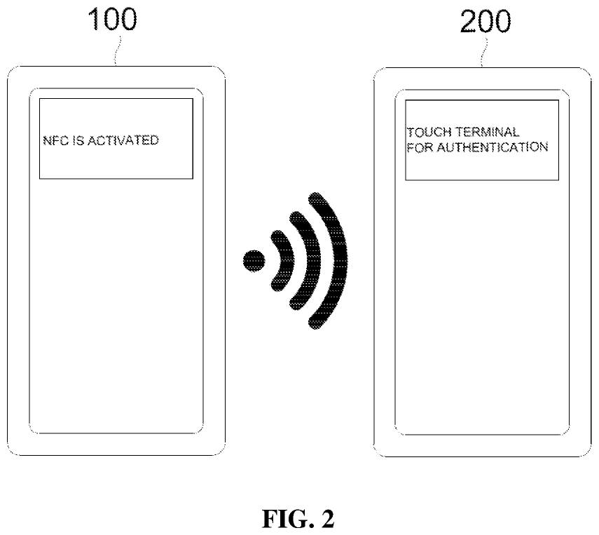

The creator terminal is configured to transmit creative work information to the administrator terminal, and the administrator terminal is configured to select valid creative work information having a high level of completion that is worthy of investment among the creative work information received from the creator terminal and upload the selected valid creative work information to the server. A method for the administrator terminal to select valid creative work information is described below with reference to FIGS. 2 to 4.

The server is configured to generate audio-visual data based on the valid creative work information uploaded by the administrator terminal and generate an NFT that corresponds one-to-one with the audio-visual data. In this case, the audio-visual data refers to data including at least one type of sound source data, image data, and video data. The server transmits the audio-visual data to the metaverse platform. In an exemplary embodiment, the server may be implemented to insert an inaudible sound wave that corresponds one-to-one with a unique code of the NFT into the audio-visual data and transmit the audio-visual data to a predetermined metaverse platform. In a further exemplary embodiment, the server may be implemented to, when the audio-visual data to be transmitted is image data having no playback time, convert the image data into video data having a playback time and insert an inaudible sound wave into the video data. By transmitting such audio-visual data having an inaudible sound wave inserted as described above, the server may determine the authenticity of the audio-visual data being streamed on the metaverse platform and protect the copyright, which will be described below.

The investor terminal is configured to exchange an NFT generated by the server with a predetermined electronic currency to receive a profit share from the income generated by audio-visual data.

The metaverse platform is configured to generate a predetermined electronic currency, use the electronic currency as money for purchase/consumption of content implemented within the platform, and receive audio-visual data from the server and stream the audio-visual data within the platform. Specifically, the metaverse platform may transmit audio-visual data received from the server to a user terminal that transmits a predetermined electronic currency, thereby performing streaming of the audio-visual data. In this case, the metaverse platform may randomly select verification data among the audio-visual data transmitted to the user terminal and transmit the selected verification data to the server, and the server may detect inaudible sound waves from the verification data to determine whether the inaudible sound waves correspond to the unique code of the NFT, thereby determining the authenticity of the audio-visual data. In a further exemplary embodiment, the server may be implemented to, upon determining that the inaudible sound wave does not correspond to the unique code of the NFT, that is, determining that the audio-visual data is forged or falsified data, retrieve the audio-visual data from the metaverse platform.

When audio-visual data is streamed on the metaverse platform as described above, the user terminal transmits an electronic currency to the metaverse platform, by which profits are generated. In this case, the metaverse platform may be implemented to transmit fees equal to a predetermined percentage of the predetermined electronic currency received from the user terminal to the server. In an exemplary embodiment, the predetermined percentage may be a value of 30% to 50%. In addition, the server may be implemented to transmit, to the creator terminal and the investor terminal, a profit share obtained by dividing the fees received from the metaverse platform according to a preset distribution ratio. Specifically, the preset distribution ratio may be implemented such that the proportions for the creator terminal, the server, and the investor terminal are the same, or each has a value of 10% to 50%. In this case, it is desirable that the fees and the profit shares are provided as the electronic currency used on the predetermined metaverse platform.

FIG. 2 is a diagram illustrating an embodiment in which an administrator terminal performs face-to-face authentication on a creator terminal according to an embodiment of the present invention.

The administrator terminal according to the embodiment of the present invention performs face-to-face authentication based on receiving near-field communication (NFC) authentication data from the creator terminal to select valid creative work information. Specifically, the administrator terminal may select creative work information as valid creative work information, and then transmit a face-to-face authentication request to the creator terminal, and based on the creator terminal responding to the request and thus a face-to-face situation being established, activate the NFC, and allow the creator terminal to touch the administrator terminal, thereby completing the authentication. The creative work information for which the face-to-face authentication has been completed as described above is uploaded to the server as valid creative work information by the administrator terminal.

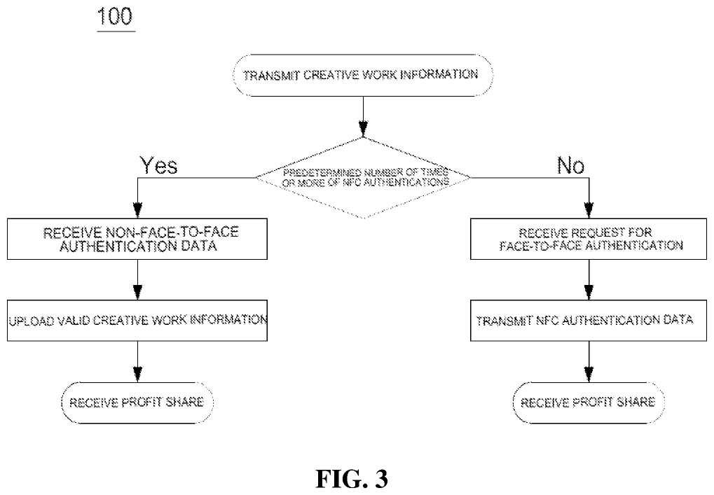

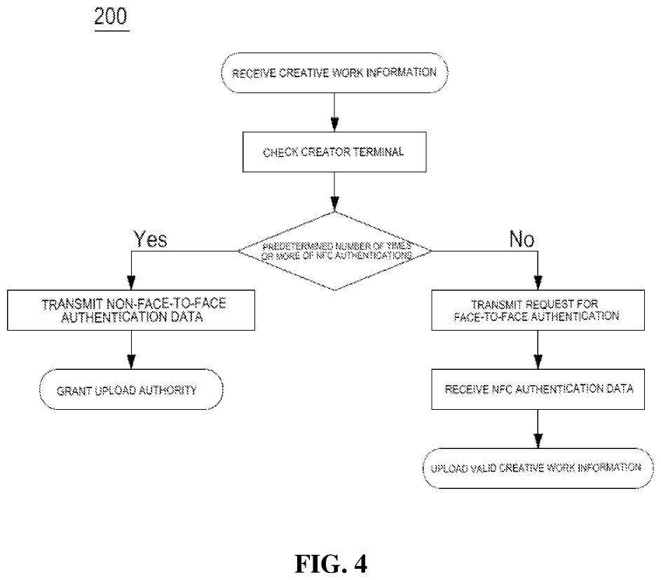

FIG. 3 is a flowchart showing a process in which a creator terminal transmits creative work information and receives a profit share according to an embodiment of the present invention, and FIG. 4 is a flowchart showing a process in which an administrator terminal selects a valid creative work information from creative work information and grants a creator terminal the authority to upload a valid creative work information according to an embodiment of the present invention.

Referring to FIGS. 3 and 4, when the creator terminal transmits creative work information to the administrator terminal, the administrator terminal selects valid creative work information from among the creative work information. The administrator terminal may, after selecting the valid creative work information, check the creator terminal that has transmitted the creative work information, and verify whether the NFC authentication of the creator terminal has been performed a predetermined number of times or more.

In this case, when the NFC authentication of the creator terminal has been performed less than the predetermined number of times, the administrator terminal transmits a face-to-face authentication request to the creator terminal. When the creator terminal wishes to respond to the request, the creator terminal transmits NFC authentication data to the administrator terminal through face-to-face authentication, and when the face-to-face authentication is completed, the administrator terminal uploads the valid creation data to the server.

On the other hand, when the NFC authentication of the creator terminal has been performed the predetermined number of times or more, the administrator terminal transmits non-face-to-face authentication data to the creator terminal. The creator terminal receives the non-face-to-face authentication data and performs authentication to thereby be granted the authority to upload a valid creative work. In other words, the creator terminal may be provided to upload valid creative work data directly to the server without a process of selection and authentication through the administrator terminal. However, when the creator terminal granted the authority to upload a valid creative work uploads valid creative work information that fails to meet a prescribed standard, the administrator terminal may discard the non-face-to-face authentication data, thereby depriving the creator terminal of the authority to upload a valid creative work.

In another exemplary embodiment, the administrator terminal may be implemented to transmit non-face-to-face authentication data when the creator terminal has performed the NFC authentication less than ten times but has received a profit share more than or equal to a predetermined amount. In this case, the predetermined number of times may be set to ten times, and the creator terminal having received a profit share may correspond to a creator terminal having performed face-to-face authentication at least once. In addition, the predetermined amount may be set to exceed 5% of the total profit shares on a monthly basis distribution.

The non-face-to-face authentication data includes a combination of a fingerprint and a voice of a user of the creator terminal, a predetermined word, and a predetermined melody. In detail, the creator terminal may, when performing non-face-to-face authentication, allow a fingerprint recognizer to recognize the fingerprint of the user of the creator terminal while a predetermined word is spoken with the voice of the user of the creator terminal user with a predetermined melody, so that non-face-to-face authentication may be completed. For example, when the predetermined word is designated as “yellow peach” and the predetermined melody is designated as “mi-re-do-re-mi-mi-mi,” the creator may allow his or her terminal to recognize the fingerprint while speaking the word “yellow peach” with the melody, thereby completing the authentication. In this case, the fingerprint and voice of the non-face-to-face authentication data, which are the creator's unique biometric data, do not change, but it is desirable that the word and the melody are implemented to change at each authentication.

According to the present invention, since valid creative information is converted into an NFT and traded using an electronic currency used within a metaverse platform, copyright disputes arising from the provision of audio-visual data within a metaverse platform can be minimized.

According to the present invention, since profits generated by providing audio-visual data within a metaverse platform are distributed based on NFTs, fair profit distribution can be ensured and the market economy can be revitalized.

According to the present invention, since face-to-face authentication a predetermined number of times or more, and then a non-face-to-face authentication device is provided, as trustworthy creators are granted the authority to select a valid creative work, the quality of creative works uploaded to a server can be improved.

According to the present invention, since inaudible sound waves are embedded into audio-visual data and the audio-visual data is transmitted to a metaverse platform, as forgery/falsification of audio-visual data streaming within a metaverse platform is identified, copyrights can be protected.

Although exemplary embodiments of the present invention have been described for illustrative purposes, those skilled in the art will appreciate that various modifications, variations, and additions are possible without departing from the scope and spirit of the present invention, and thus these various modifications, variations, and additions fall within the scope of the claims. In addition, those skilled in the art will appreciate that various substitutions, deformations, and variations are possible without departing from the spirit of the present inventions, and thus the present invention is not limited by the above described embodiments and accompanying drawings.

In the above-described exemplary system, the methods are described on the basis of a flowchart as a series of operations or blocks, but the present invention is not limited to the order of the operations, and some operations may occur simultaneously or in a different order or as different operations from the above. Those skilled in the art will appreciate that the operations shown in the flowchart are not exclusive and that other operations may be included or that one or more operations in the flowchart may be deleted without affecting the scope of the present invention.

What is claimed is:

1. An entertainment system comprising:
a creator terminal configured to transmit creative work information;
an administrator terminal configured to select valid creative work information among the creative work information received from the creator terminal;
a server configured to generate audio-visual data based on the valid creative work information uploaded by the administrator terminal and generate a non-fungible token (NFT) that corresponds one-to-one with the audio-visual data;
an investor terminal configured to exchange the NFT generated by the server with a predetermined electronic currency; and
a predetermined metaverse platform configured to generate the predetermined electronic money,
wherein the administrator terminal is configured to:
perform face-to-face authentication based on receiving near-field communication (NFC) authentication data from the creator terminal to select the valid creative work information;
transmit non-face-to-face authentication data to a creator terminal that has performed the face-to-face authentication a predetermined number of times or more or a creator terminal that has performed the face-to-face authentication one or more times and has received a profit share more than or equal to a predetermined amount to grant the creator terminal valid creative work upload authority, wherein the non-face-to-face authentication data includes a combination of a fingerprint and a voice of a user of the creator terminal, a predetermined word, and a predetermined melody; and
discard the non-face-to-face authentication data to deprive the creator terminal of the valid creative work upload authority when the creator terminal granted the valid creative work upload authority uploads valid creative work information that fails to meet a prescribed standard.

2. The method of claim 1, wherein the server is configured to:
insert an inaudible sound wave that corresponds one-to-one with a unique code of the NFT into the audio-visual data and transmit the audio-visual data to the predetermined metaverse platform; and
when the audio-visual data is image data having no playback time, convert the image data into video data having a playback time and insert the inaudible sound wave into the video data.

3. The method of claim 2, wherein the metaverse platform is configured to:
transmit, to a user terminal transmitting the predetermined electronic currency to the metaverse platform, the audio-visual data received from the server; and
randomly selects verification data from among the audio-visual data and transmit the verification data to the server,
wherein the server is configured to:
detect the inaudible sound wave from the verification data;
determine whether the inaudible sound wave corresponds to the unique code of the NFT; and
upon determining that the inaudible sound wave does not correspond to the unique code of the NFT, retrieve the audio-visual data from the metaverse platform.

4. The method of claim 1, wherein the metaverse platform is configured to transmit fees equal to a predetermined percentage of the predetermined electronic currency received from the user terminal to the server, and
the server transmits, to the creator terminal and the investor terminal, a profit share calculated by dividing the fees according to a preset distribution ratio, wherein the fees and the profit share are the electronic currency used on the metaverse platform.
